(19) United States
(12) Patent Application Publication
(10) Pub. No.: US 2011/0126718 A1
(43) Pub. Date: Jun. 2, 2011

(54) Coffee Machine

(75) Inventor: Jens Martin Meuer, Duisburg (DE)

(73) Assignee: WIK Far East Ltd., North Point (HK)

(21) Appl. No.: 12/958,316

(22) Filed: Dec. 1, 2010

(30) Foreign Application Priority Data
Dec. 1, 2009 (DE) 20 2009 015 681.8

(51) Int. Cl. A23L 2/54

(52) U.S. Cl. 99/323.1

(57) ABSTRACT

A coffee machine 1 comprises a brewing unit 2 and at least one outlet 7 for delivering the brewed coffee and at least one outlet 7.1 for delivering the second beverage component. Moreover, this coffee machine 1 comprises a foaming device 17 applied to the at least one second outlet 7.1. The outlets 7, 7.1 are part of an outlet module 2 that can move relative to the foaming device 17 and the brewing unit 27. This ensures that the at least one outlet 7.1 to which the foaming device 17 can be applied is connected to a line 13 with a coupling element 14 at its free end for docking of the line 13 to the exit 16 of the foaming device 17. In the position of the outlet module 2 for delivery of a beverage, the coupling element 14 is held docked to the exit 16 of the foaming device 17. The outlet 28 of the brewing unit 27 is arranged with its exit 29 relative to the outlet module 2 so that the coffee flowing from it flows by gravity into a coffee collector 8 of the outlet module 2, to which collector 8 the at least one coffee outlet 7 is connected.

### CROSS REFERENCE APPLICATIONS

This application claims the benefit of German Application No. 20 2009 015 681.8, filed Dec. 1, 2009, which is incorporated herein by reference for all purposes.

### BACKGROUND

The invention relates to a coffee machine with a brewing unit and at least one outlet for delivering the brewed coffee and at least one outlet for delivering the second beverage component and with a foaming device applied to the at least one second outlet.

Coffee machines as beverage making machines when designed as so-called fully automatic machines have a brewing unit into which the ground coffee required to make the coffee is placed. The outlet of the brewing unit is connected to an outlet of the beverage machine. This is located above a drinking vessel stand, on which a drinking vessel can be placed to catch the brewed coffee flowing out from the beverage outlet in the course of the preparation of a coffee beverage. Such coffee machines can be designed to prepare mixed coffee and milk beverages. These types of machines have a device for preparing this additional beverage component besides a brewing unit. Often, it can be a milk foaming device. In the milk foaming device, milk is drawn in from a storage container, foamed, and delivered through an outlet, making use of hot steam produced in the coffee machine. Besides coffee machines in which the milk foaming device or its outlet is located at a distance from the outlet of the brewing unit on the machine, there have also become known coffee machines in which the milk outlet is arranged in the area of the outlet for delivery of the brewed coffee. One such device is specified in DE 20 2006 002 124 U1. In this prior art hot beverage making machine, the outlet for the brewed coffee as the first beverage component and the outlet for a milk foam as the second beverage component are located in direct proximity to each other. This allows both beverage components to be delivered from the pair of outlets into a drinking vessel positioned underneath them without having to move the drinking vessel around.

A coffee machine is known from EP 0 820 715 A1, in which the two outlets are combined into one structural unit, being arranged concentrically to each other. This ensures that brewed coffee flows out from the inner outlet and foamed milk as another beverage component flows out through the annular gap surrounding this, formed by the outer pipe. One part of this prior art outlet module is a foaming device, by which the milk is drawn in and foamed in an emulsifier chamber by being subjected steam. The exit of the emulsifier chamber emerges into the annular gap surrounding the inner outlet. Webs are arranged in the outlet along the lengthwise dimension to suppress or present a squirting out of milk components from the outlet due to the foaming process. This outlet module is connected to a coffee outlet line to bring up the coffee brewed in the brewing unit and to a hot steam supply line. The parts of the outlet module can be separated from each other for cleaning purposes.

Given the design of this outlet module with the foaming device integrated therein, it requires a certain structural depth and is not suited for applications in which the outlet module is supposed to be part of a door or flap that is to be moved or swiveled relative to the other components of the coffee machine to open and close the housing.

The foregoing example of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

The present disclosure is an aforementioned coffee machine where the outlets are part of an outlet module that can move relative to the foaming device and the brewing unit. The at least one outlet for the foaming device is connected to a line with a coupling element at its free end for docking the line to the exit of the foaming device. The coupling element in the delivery of beverage position of the outlet module is docked to the exit of the foaming device. The outlet of the brewing unit has its exit relative to the outlet module so that the coffee flowing from it is gravity feed into a coffee collector of the outlet module, to which collector the at least one coffee outlet is connected.

In this coffee machine the outlet module is separated from the foaming device and the brewing unit. Two interfaces are provided to supply the brewed coffee and, for example, foamed milk as a further beverage component. It has a coffee collector to supply the brewed coffee to the outlet module and to the outlet located therein. This is open at the top and in the position of the outlet module for delivery of a beverage it is arranged so that the collector is arranged underneath the exit of the brewing unit, so that the coffee flowing out from it can be gravity fed into the collector. The exit of the brewing unit can be the actual exit of the latter or the exit of a coffee drain line. Thus, the arrangement with the exit of the brewing unit in the vertical direction above the collector and the flowing of the coffee by gravity into the collector forms one of the interfaces.

For the connecting of the outlet or outlets of the outlet module to dispense the additional beverage component, especially for the dispensing of foamed milk, the at least one outlet of the outlet module is connected to a line with a coupling element at its free end. This is designed for docking to the exit of the foaming device. This line with its coupling element is part of the outlet module. Since the coupling element is designed to hold the exit of the foaming device in a docked position when the outlet module is located in its position for the dispensing of a beverage, and a docking is produced simply by bringing up the coupling element to the exit of the milk foaming device, this can also be easily separated from the foaming device. The coupling element preferably lies against the exit of the foaming device with a pretension for the dispensing of a beverage. The pretension functions to sealed off the coupling element at the exit of the foaming device. Thus, the force of the pretensioning does not need to be especially high. A form fitting connection is also possible in addition or also in place of a connection of the coupling element to the exit of the foaming device by pretensioning. The coupling element on the one hand and the exit of the foaming device on the other hand thus form the second interface between the outlet module and the other components of the coffee machine. By providing these interfaces, the foaming device itself is located inside the housing of the coffee machine. Therefore, the outlet module can be designed slender in its depth and thanks to the aforementioned interfaces it can be easily moved relative to the foaming device and the brewing unit, as well as the other components of the coffee machine, for example, swung away as part of a door for these elements.

This design means that there must be a line between the exit of the foaming device, i.e., the exit of the emulsifying chamber, and the at least one connectable outlet, by which the foamed milk must flow to the outlet. Thanks to the distance of the outlet end of the milk foam outlet of the outlet module from the emulsifier chamber, basically no further measures need to be taken to avoid an unwanted spraying of foamed milk. Instead, this line has the effect that milk foam transported through the latter flows out very uniformly at the outlet end. Furthermore, it is observed that the emerging milk foam is especially fine-pored in this design.

The two outlets can be combined into one structural unit, for example, they can be arranged concentrically to each other. In such a configuration, it is specified that the inner outlet can be connected to the foaming device by the line with the coupling element at its free end and the brewed coffee flows out through the annular gap surrounding this outlet or the outer outlet. In this configuration, the brewed coffee flows against the outer wall of the inner outlet so that the dispensing end of the inner outlet is freed of milk residue in this way, or at least it cannot build up on it. The two outlets of such an outlet unit can also be arranged to lie adjacent to each other in the manner of a double pipe.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a perspective view of a coffee machine with an outlet module.

FIG. 2 is a longitudinal section through one segment of the coffee machine of FIG. 1 along a first plane.

FIG. 3 is an enlarged segment of parts of the section of the coffee machine of FIG. 2.

FIG. 4 is a longitudinal section through one segment of the coffee machine of FIG. 1 along a plane parallel to the first plane.

FIG. 5 is bottom perspective the outlet module of the coffee machine of FIG. 1 without the coffee machine.

FIG. 6 is the rear perspective view of outlet module of FIG. 5.

FIG. 7 is a perspective view of and second embodiment of the outlet module with the coffee machine not shown.

FIG. 8 is a longitudinal section through the outlet module of FIG. 7.

FIG. 9 is a sectional view through the outlet module of FIGS. 7 and 8.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION OF THE DRAWINGS

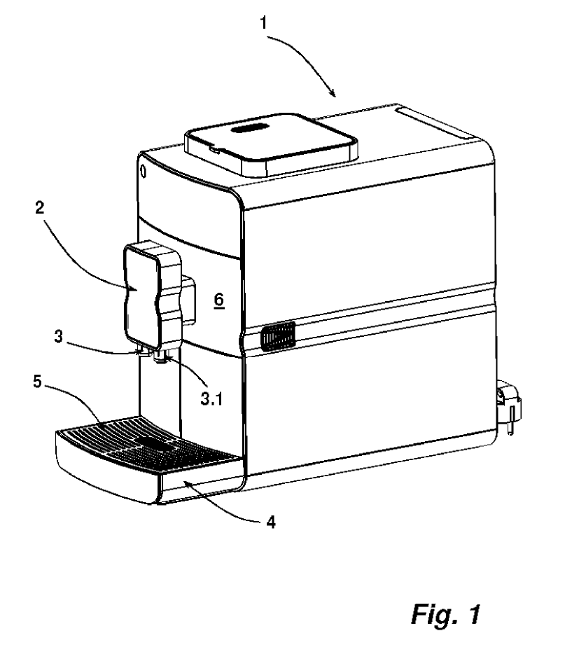

A coffee machine 1 is designed as fully automatic. On the front side of the coffee machine 1 is an outlet module 2, which in the depicted embodiment depicted has two double outlets 3, 3.1, which are described in detail hereinafter. Beneath the outlet module 2 is a drip collecting container 4 with a grate 5 coving the top. The outlet module 2 is connected to a door 6 of the housing of the coffee machine 1. The door 6 can swing on a vertical axis extending in the region of the right hand edge, recognizable in FIG. 1. A locking means holds the door 6 in the closed position of the door 6, shown in FIG. 1. The position of the door with the outlet module 2 as shown in FIG. 1 is the position of the outlet module 2 when preparing a beverage.

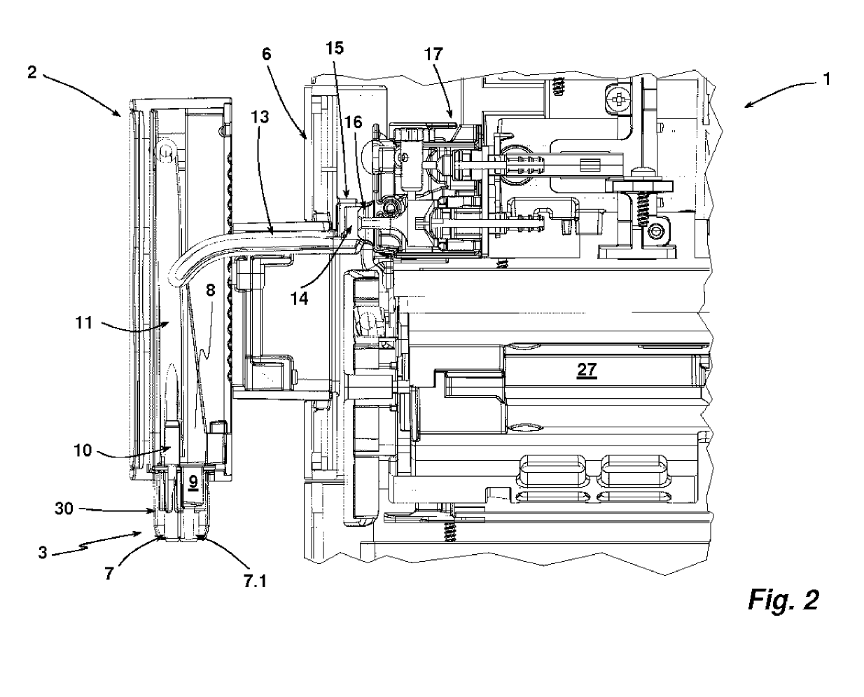

FIG. 2 a longitudinal sectional view of part of the interior of the coffee machine 1 and the outlet module 2 connected to the door 6. The plane of the section is located in the region of the double outlet 3. In the coffee machine 1, the double outlets 3, 3.1, as recognizable from FIG. 2, are designed as a structural unit with adjacent outlets 7, 7.1 formed as a double pipe where the individual pipes are molded one onto the other. The outlet 7.1 forms the exit of a coffee collector 8, open at the top. In the depicted embodiment there is a step like recess 9 toward the outlet 7.1. Adjacent to the recess 9 is a hose connector 10, on which a silicone hose 11 is pressed. In identical manner, a silicone hose is placed on the corresponding connector of the double outlet 3.1. The two silicone hoses 11 are connected via a T-piece 12 to a common supply line 13, as seen in FIG. 6. The supply line 13 has at its free end a pot-like coupling element 14. The coupling element 14 is molded onto the line 13 and therefore consists of the same material as the line 13. In the depicted embodiment the line 13 and the coupling element are made from silicone material. The coupling element 14 is held in a mounting 15 of the door 6. The mounting 15 embraces the upper part of the coupling element 14 in the manner of a clasp. The coupling element 14 can be introduced into the mounting 15 by making use of the elastic properties of the coupling element 14. Since the coupling element 14 is held in the mounting 15 of the door 6, it will move along with the outlet module 2 when the door 6 is swung, say, to move it open from its position shown in FIGS. 1 and 2. The coupling element 14 is braced from behind against a wall as an abutment to provide the necessary pressing force (pretensioning) for a tight connection in the docking position in the sample embodiment depicted.

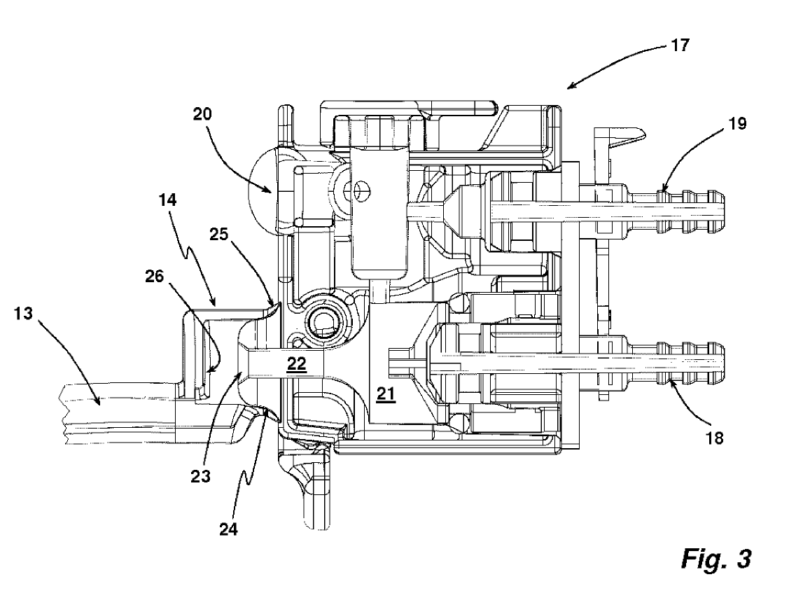

The coupling element 14 and the connection of the coupling element 14 in the position of the outlet module shown in FIG. 2 are seen in detail in FIG. 3. In the position shown in FIG. 2, the coupling element 14 is docked at the exit 16 of a foaming device 17. In FIG. 3, the foaming device 17 is shown removed from the coffee machine 1 with the coupling element 14 attached to it. The foaming device 17 has two hose nozzles 18, 19 at the side opposite the exit 16. Hot steam can be applied to the foaming device 17 by the hose nozzle 18 and an attached hose. Air for the milk foaming (emulsifying) process can be introduced into the foaming device 17 by the hose nozzle 19 and an attached hose. A milk supply channel 20 is shown in the cross sectional view of FIG. 3. The milk supply channel 20 is pointing toward the front side of the foaming device 17, so that a milk hose can be introduced at the front side through an opening of the coffee machine 1 and be shoved into the milk supply channel 20.

The foaming device 17 works by the familiar Venturi principle, wherein milk is drawn into the emulsifying chamber 21 through a milk supply hose inserted in the milk supply channel 20 when hot steam is applied to the emulsifying chamber and emulsified therein. The emulsified milk emerges through an exit channel 22 from the emulsifying chamber 21. The exit 16 of the foaming device 17 is located the in region of the mouth 23 of the exit channel 22. Its outer envelope surface 24 is S-shaped in longitudinal section and tapers toward the mouth 23, as can be seen from FIG. 3. Such an envelope surface 24 serves as a docking surface for the pot like coupling element 14, on which the coupling element 14 can dock in tight manner. FIG. 3 shows the docked position of the coupling element 14 on the exit 16 of the foaming device 17. The coupling element 14 is held in this position by the mounting 15 secured to the door 6 (neither of them shown in FIG. 3).

The pot like coupling element 14 has at its free end a liplike collar 25 which narrows toward the free end. Due to this narrowing, the collar 25 is more elastic than the other segments of the coupling element 14, so that it can fit especially well against the envelope surface 24, especially against its rear connection region. When the coupling element 14 is docked at the exit 16 of the foaming device 17, the coupling element 14 acts under pretensioning against the envelope surface 24, as seen in FIGS. 2 and 3. The distance between the clasp like mounting 15 and the coupling element 14 contained therein is appropriately dimensioned in the closed position of the door 6. The coupling element 14 projects in the axial direction from the mounting 15 in the direction of the foaming device 17 for purposes of pretensioning.

The supply line 13 is molded off-center on the coupling element 14. Thus, the bottom 26 of the coupling element 14 serves as a baffle plate for the foamed milk streaming out from the exit channel 22. The flowing of foamed milk into the line 13 and, accordingly, the flowing of foamed milk out from the outlets 7 is improved and a spraying is effectively prevented due to this feature.

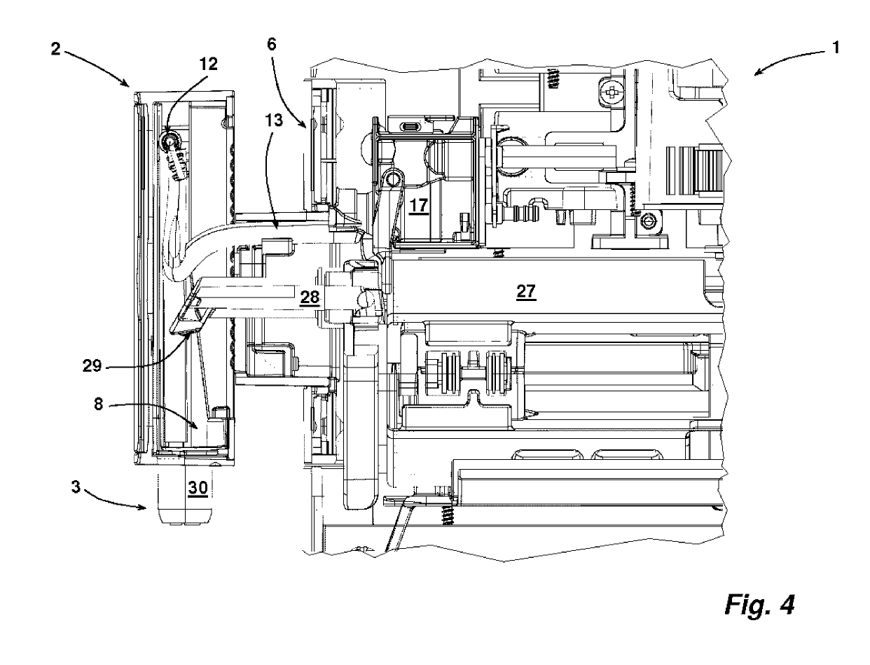

In the cross sectional view of FIG. 4, whose sectional plane is located between the double outlets 3, 3.1, one can see the brewing unit 27 of the coffee machine with its outlet 28. The outlet 28 projects out beyond the front boundary of the coffee machine 1 itself into the inside of the outlet module 2. The mouth 29 of this outlet 28 is situated vertically above the collector 8, so that in the position of the outlet module 2 brewed coffee flowing out from this drops by gravity into the collector 8 or collector 8.1, as shown in FIG. 4. The outlet of the brewing unit 27 is divided such that one segment is above the collector 8 and the other segment above the collector 8.1.

The design of the interfaces between the outlet 28 of the brewing unit 27 and the collectors 8, 8.1 of the outlet module 2 as well as the interface between the supply line 13 with its coupling element 14 belonging to the outlet module 2 and the foaming device 17 make it clear that the outlet module 2 can be moved easily relative to the other parts of the coffee machine 1 and, thus, especially relative to the foaming device 17 and the brewing unit 27, in particular, it can be swiveled. This is necessary in order to be able to take the foaming device 17 out of the coffee machine 1 and clean it. The same holds for the brewing unit 27. Instead of a swivel ability of the doors 6, as shown in the depicted embodiment, these can also be designed so that they can be removed from the coffee machine.

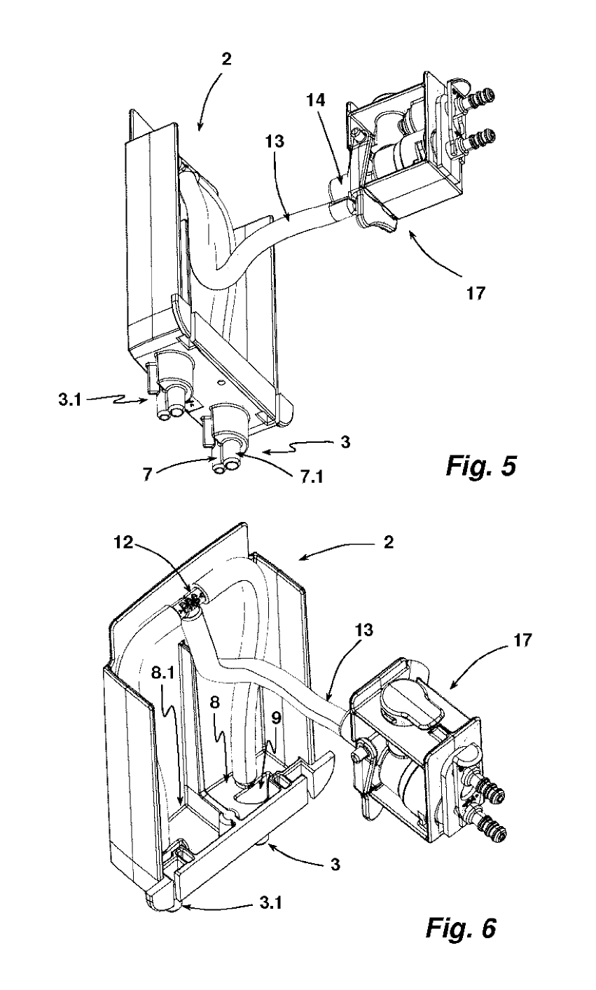

FIG. 5 shows the outlet module 2 in a bottom perspective view, without the design pipe 30 recognizable in FIG. 4, enclosing the outlets 7, 7.1. The configuration of the collectors 8, 8.1 of the outlet module 2 can be seen in FIG. 6.

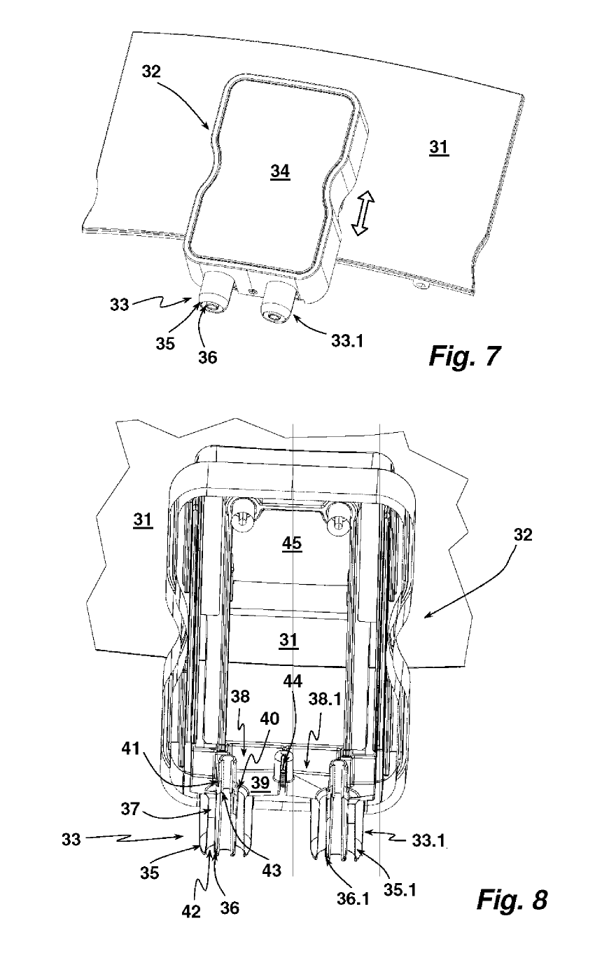

Another embodiment is shown in FIG. 7, with a front part 31 of a housing of a coffee machine, not further illustrated. A beverage machine outlet 32 is connected to the front part 31. The beverage outlet 32—or outlet module—can be adjusted relative to the front part 31, as indicated by the double arrow in FIG. 7. This feature serves to adjust the distance of the beverage outlet 32 from a drinking vessel support surface located underneath the outlet 32 of the coffee machine. The beverage outlet 32 is designed as a double outlet for the simultaneous filling of two drinking vessels. The beverage outlet 32 has two identically designed outlets 33, 33.1 for this reason. In the depicted embodiment, these are arranged with their dispensing ends projecting from a cover 34 lining the exterior side of the beverage outlet. The front part 31, just like the door 6 of the embodiment 1 to 6, can swivel relative to the other parts of the coffee machine.

The outlet 33 is described in greater detail below. The outlet 33.1 is designed accordingly. As can be seen from FIG. 7, the outlet 33 is designed as a double pipe, namely, it is formed from an outer outlet pipe 35 and an inner outlet pipe 36 arranged concentrically inside the former. The outlet 33 is designed so that different beverage components can be dispensed from the two outlet pipes 35, 36.

The inner outlet pipe 36, as can be seen from FIG. 8, is joined to the inner wall of the outer outlet pipe 35 by several spokes 37 projecting radially from the outer wall of the outlet pipe 36 and supported in this way. In the depicted embodiment, the spokes 37 are located in the mouth region of the outer outlet pipe 35 at the entrance side. The outer outlet pipe 35 is molded on a collector 38. The collector 38 forms a catching vessel for catching the beverage component being dispensed through the outer outlet pipe 35. The bottom 39 of the collector 38 is designed with a slope in the direction of the mouth 40 of the outer pipe 35 so that the beverage component placed therein flows out without residue from the collector 38 through the outlet pipe 35. For this purpose, the collector 38 can be lined with a coating that facilitates this flow.

The inner outlet pipe 36 is arranged to reach into the outer outlet pipe 35, and it is led out across the bottom 39 of the collector 38 to provide a hose connection segment 41. The hose connection segment 41 serves for placement of a hose segment to connect the outlet pipe 36 to a milk foaming device. Thus, the outlet pipe 36 serves to dispense milk foam, while the outlet pipe 35 serves to dispense brewed coffee.

As can be seen from FIG. 8, in the depicted embodiment the outer envelope surface of the inner outlet pipe 36 is cylindrical, while the inner envelope surface of the outer outlet pipe 35 conical shape, such that the width of the annular space 42 located between the two pipes 35, 36 increases from the region of the mouth 40 to the dispensing end. This improves the draining of the beverage component placed in the collector 38 by preventing back pressure. The inner outlet pipe 36 is likewise conical at the dispensing end, and with a diameter increasing toward its dispensing end. The region of the hose connection segment 41 is designed oppositely conical. The two interlocking conical segments form inside the outlet pipe 36 a shoulder 43 which abruptly increases the free cross sectional area toward the dispensing end of the outlet pipe 36. This shoulder 43 serves the purpose that the milk foam delivered to the outlet pipe 36 has an opportunity to relax its pressure suddenly (over a short distance) before the milk foam flows out from the outlet pipe 36, which achieves a special quality for the milk foam. A shoulder corresponding to the shoulder 33 of this depicted embodiment is likewise present in the milk foam outlet 7 of the sample embodiment of FIGS. 1 to 6.

In the depicted embodiment, the beverage outlet 32 is designed as a double outlet, so the collector 38 is likewise designed as a double collector. The double collector is separated by a partition wall 44 which separates the collector 38 as the first collector segment from the collector segment 38.1 for the other outlet of the double outlet. A hose segment is placed on each hose connection segment for the supplying of milk foam to the two inner outlet pipes 36, 36.1 of the two outlets 33, 33.1. The hose segments are brought together across a Y-piece and connected to the milk foaming device.

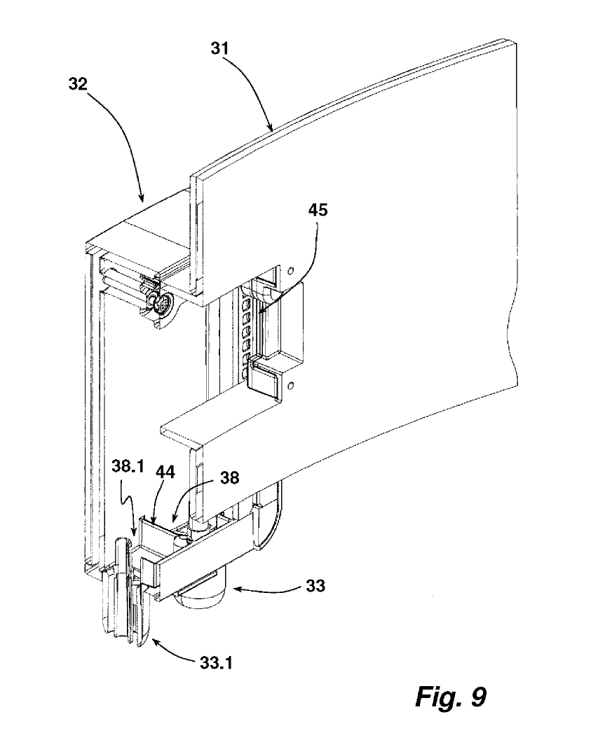

The front part 31 has an opening 45 that the outlet of a brewing unit associated with the coffee machine projects through, so that the coffee beverage brewed in the brewing unit can flow out from the outlet of the brewing unit and into the two collector segments 38, 38.1 of the double collector. The opening 45 of the front part 31 can be seen in the perspective rear cross sectional view on the front part 31 of FIG. 9. The connection line for connecting the two inner outlet pipes 36, 36.1 to the milk foaming device is also led through this opening 45.

When dispensing a beverage, the particular beverage component can be dispensed from the two outlet pipes 35, 36 of an outlet 33 or 33.1 at the same time or also displaced in time relative to each other. This is done according to the mixed beverage desired. In the sample embodiment shown, the terminal part of the dispensing end of the particular inner outlet pipe 36, 36.1 is situated inside the mouth of the outer outlet pipe 35 or 35.1. This ensures that, when simultaneously dispensing milk foam and coffee beverage or when the coffee machine is operating to first dispense the milk foam and then the coffee beverage, the outside of the particular inner outlet pipe 36, 36.1 is freed of clinging residue of milk foam by the coffee beverage flowing against the outer envelope surface of the inner outlet pipe 36, 36.1, or such residue cannot even build up on it.

The invention has been described by means of sample embodiments, in which the two interlocking outlets are designed as concentric double pipe outlets. It is equally possible to arrange the two outlets eccentrically to each other. What is more, the person versed in the art can conceive of additional possible configurations, without leaving the scope of the claims, to realize the invention, without it being necessary to discuss these in detail.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

### LIST OF REFERENCE NUMBERS

1 coffee machine 31 front part
2 outlet module 32 beverage outlet
3, 3.1 double outlet 33, 33.1 outlet
4 collector container 34 cover
5 grating 35, 35.1 outer outlet pipe
6 door 36, 36.1 inner outlet pipe
7, 7.1 outlet 37 reservoir
8 collector 38, 38.1 collector, collector segment
9 recess 39 bottom
10 connection nozzles 40 mouth
11 hose 41 hose connection segment
12 T-piece 42 annular space
13 supply line 43 shoulder
14 coupling element 44 partition
15 mounting 45 opening
16 exit
17 foaming device
18 hose nozzle
19 hose nozzle
20 milk supply channel
21 emulsifying chamber
22 exit channel
23 mouth
24 envelope surface
25 collar
26 bottom
27 brewing unit
28 outlet
29 mouth
30 design pipe

I claim:

1. A coffee machine with a brewing unit comprising:
and at least one coffee outlet;
at least one second beverage outlet;
foaming device associated with the at least one second beverage outlet;
the outlets being part of an outlet module, said outlet module being movable relative to the foaming device and the brewing unit;
wherein the at least one second beverage outlet to which the foaming device can be applied is connected to a line connected at a free end via a coupling to an exit of the foaming device;
when the outlet module is in a position for wherein delivery of a beverage, the coupling element in the held docked to the exit of the foaming device; and
an outlet of the brewing unit has an exit arrange relative to the outlet module such that the coffee flowing from the exit is gravity fed into a coffee of the outlet module, to which collector the at least one coffee outlet (7; 35, 35.1) is connected.

2. The coffee machine of claim 1, wherein in the position of the outlet module for dispensing a beverage, the coupling element is held under pretensioning and docked to the exit of the foaming device via elastic restoring forces of a flexible line carrying the coupling element.

3. The coffee machine of claim 1, wherein the coupling element is held in a mounting of a structural part coordinated with the outlet module such as a door and the mounting forms an abutment for the tight docking of the coupling element to the exit of the foaming device.

4. The coffee machine of claim 3, wherein the coupling element in the docked position at the exit of the foaming device thrusts against the envelope surface of the exit with a certain pretensioning.

5. The coffee machine of claim 1, wherein the exit of the foaming device has an S-shaped docking surface in longitudinal section, embracing an outlet channel against which the coupling element of the line lies with its complementary docking surface in its docked position.

6. The coffee machine of claim 5, wherein the coupling element is pot-shaped and its docking surface is designed as a lip-shaped collar.

7. The coffee machine of claim 6, wherein the thickness of the collar decreases toward its outer terminal end.

8. The coffee machine of claim 1, wherein the line is a silicone hose on which the coupling element is molded.

9. The coffee machine of claim 8, wherein the line is connected off-center to the pot-shaped coupling element.

10. The coffee machine of claim 1, wherein the outlet module is part of a door of the housing of the coffee machine.

11. The coffee machine of claim 10, wherein the door can be moved about a vertical swivel axis from its closed position to its open position and vice versa.

12. The coffee machine of claim 11, wherein the door in its closed position, which constitutes the position of the outlet module for dispensing a beverage, is held closed by a closing means, such as a magnet or a bolt lock that opens and closes by pressure change.
